(19) United States
(12) Patent Application Publication
(10) Pub. No.: US 2017/0071309 A1
(43) Pub. Date: Mar. 16, 2017

(54) Luggage with Detachable Power Supply Unit

(71) Applicant: Solite International Co., Ltd., Changhua City (TW)

(72) Inventor: Yu-Chi Chen, Changhua City (TW)

(21) Appl. No.: 14/852,685

(22) Filed: Sep. 14, 2015

(51) Int. Cl. A45C 15/00; G01G 19/52; A45C 5/03; A45C 13/10; H04W 84/12; H04W 4/00

(52) U.S. Cl. CPC A45C 15/00; H04W 84/12; H04W 4/008; A45C 5/03; A45C 13/10; G01G 19/52

(57) ABSTRACT

A luggage includes a housing, a wireless communication module, a control module, an accessory assembly, and a detachable power supply. The wireless communication module is disposed in the housing and is configured to detect and receive a signal sent from a portable device. The control module is disposed in the housing and is coupled to the wireless communication module. The control module is adapted to determine the signal received by the wireless communication module. The accessory assembly is coupled with and actuated by the control module. The detachable power supply is detachably mounted on the housing. The detachable power supply is coupled to the wireless communication module, the control module, and the accessory assembly. The detachable power supply is configured to supply the wireless communication module, the control module, and the accessory assembly with electric power.

### BACKGROUND

The present invention relates to a luggage and, more particularly, to a luggage including a detachable power supply to supply the power to built-in accessories.

U.S. patent application Ser. No. 14/085,039, published on Jun. 5, 2014, discloses a luggage article, which includes an electronic processing module, and a power supply unit coupled to the processing module and configured to supply the processing module with electric power. The electronic processing module has a communication module, which may for example be a Bluetooth module, an RFID module, a GPRS module, a GSM module, a UMTS module, an LTE module, a WiMAX module, a WLAN module or any other suitable wireless communication module. The communication module may also serve as reception device for any other queries or signals, such as a locking request of the luggage article, an update request for flight information, an update of the stored baggage weight, any ID numbers connected with purchased travel tickets and the like.

However, the transmitting or wireless-enabled devices such as Bluetooth, Wi-Fi and remote controlled products must not be used on the aircraft at any time. These devices can interfere with aircraft navigation, communications and control systems. Thus, the luggage article with processing module is not allowed to use on the aircraft, so the user must remove or turn off the power supply unit before boarding the aircraft. Nonetheless, removing or turning off the power supply unit is easy to forget, especially hurrying to catch the airplane.

Thus, a need exists for a novel luggage to mitigate and/or obviate the above disadvantages.

### BRIEF SUMMARY

This need and other problems in the field of luggages are solved by a luggage including a housing, a wireless communication module, a control module, an accessory assembly, and a detachable power supply. The wireless communication module is disposed in the housing and is configured to detect and receive a signal sent from a portable device. The control module is disposed in the housing and is coupled to the wireless communication module. The control module is adapted to determine the signal received by the wireless communication module. The accessory assembly is coupled with and actuated by the control module. The detachable power supply is detachably mounted on the housing. The detachable power supply is coupled to the wireless communication module, the control module, and the accessory assembly. The detachable power supply is configured to supply the wireless communication module, the control module, and the accessory assembly with electric power.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a block diagram of a luggage with a detachable power supply according to the present invention.

FIGS. 2 and 3 show a lock assembly of the detachable power supply according to the present invention and illustrate the detachable power supply how to connect to a housing of the luggage.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood.

Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “bottom”, “side”, “end”, “portion”, “section”, “spacing”, “length”, “depth”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

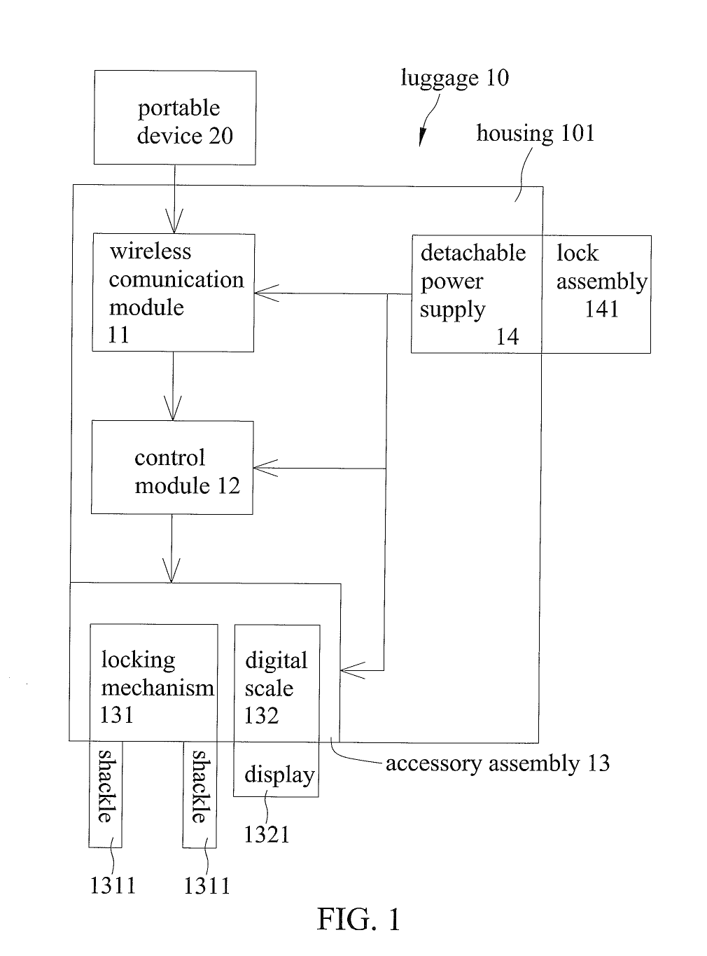

FIG. 1 shows a block diagram of a luggage 10 according to the present invention. The luggage 10 may be used for travelling on board of an aircraft, particularly in connection with intermodal travel or mixed-mode commuting.

The luggage 10 includes a housing 101, a wireless communication module 11, a control module 12, an accessory assembly 13, and a detachable power supply 14.

The housing 101 may be a hard shell, for example made from metal or a plastics material, or a soft shell, for example made from woven fabric. The housing 101 may be generally cuboidal in shape and includes a side surface, a top surface, and a front surface. The top surface may be equipped with a handle such as a strap or carrying handle. The front surface may be implemented as lid for the luggage 10, which may be swung open to access an inner portion of the luggage 10 enclosed by the housing 101.

The wireless communication module 11 is disposed in the housing 101. The wireless communication module 11 is configured to detect and receive a signal sent from a portable device 20, such as a smartphone. The wireless communication module 11 may for example be a Bluetooth module, an RFID module, a GPRS module, a GSM module, a UMTS module, an LTE module, a WiMAX module, a WLAN module or any other suitable wireless communication module. The portable device 20 has an emitter adapted for send out the signal corresponding to the wireless communication module 11.

The control module 12 is disposed in the housing 101 and is coupled to the wireless communication module 11. The control module 12 is adapted to determine the signal received by the wireless communication module 11. The control module 12 may include a central processing unit 121 (CPU), a memory 122, and an acceptor 123. The CPU 121 may be implemented as a general purpose processor, an application specific integrated circuit (ASIC), one or more field programmable gate arrays (FPGAs), a group of processing components, or other suitable electronic processing components. The memory 122 is one or more devices (e.g., RAM, ROM, Flash memory, hard disk storage, etc.) for storing data and/or computer code for completing and/or facilitating the various processes described herein. The memory 122 may be or include non-transient volatile memory or non-volatile memory. The memory 122 may be integrated with the CPU 121 or separate from the CPU 121. The memory 122 may include database components, object code components, script components, or any other type of information structure for supporting the various activities and information structures described herein. The memory 122 is connected to the CPU 121 and may include computer code or instructions for executing one or more processes described herein. The acceptor 123 is adapted to determine the signal received by the wireless communication module 11. It should be appreciated that the control module 12 may be or include one or more PCBs containing an integrated circuit or circuits for completing the activities described herein. The CPU 121 may be one or more integrated circuits having firmware for causing the circuitry to complete the activities described herein.

The accessory assembly 13 is coupled with and actuated by the control module 12. In the embodiment, the accessory assembly 13 includes a locking mechanism 131 and a digital scale 132. The locking mechanism 131 has a pair of shackles 1311 to lock the luggage 10. The signal received by the wireless communication module 11 is provided to the CPU 121 of the control module 12. The CPU 121 may determine whether a correct unlock code was provided through the wireless communication module 11 by comparison of the unlock code with a code stored in the memory 122 accessible by the CPU 121. If a correct unlock code is provided, the CPU 121 signals an actuator 124, such as a motor to unlock the pair of the shackles 1311 of the locking mechanism 131. The digital scale 132 is adapted to measure a total weight of the luggage 10 and has a display 1321 to indicate the total weight of the luggage 10. The display 1321 may for example be a liquid crystal display (LCD), a light emitting diode (LED) display, an electronic ink display, a bi-state display or any other suitable electronic display device. The display 1321 may be oriented substantially planar with the respective surface of the luggage 10 in which the display 1321 is embedded. For example, the display 1321 may also be arranged on the top surface of the housing 101.

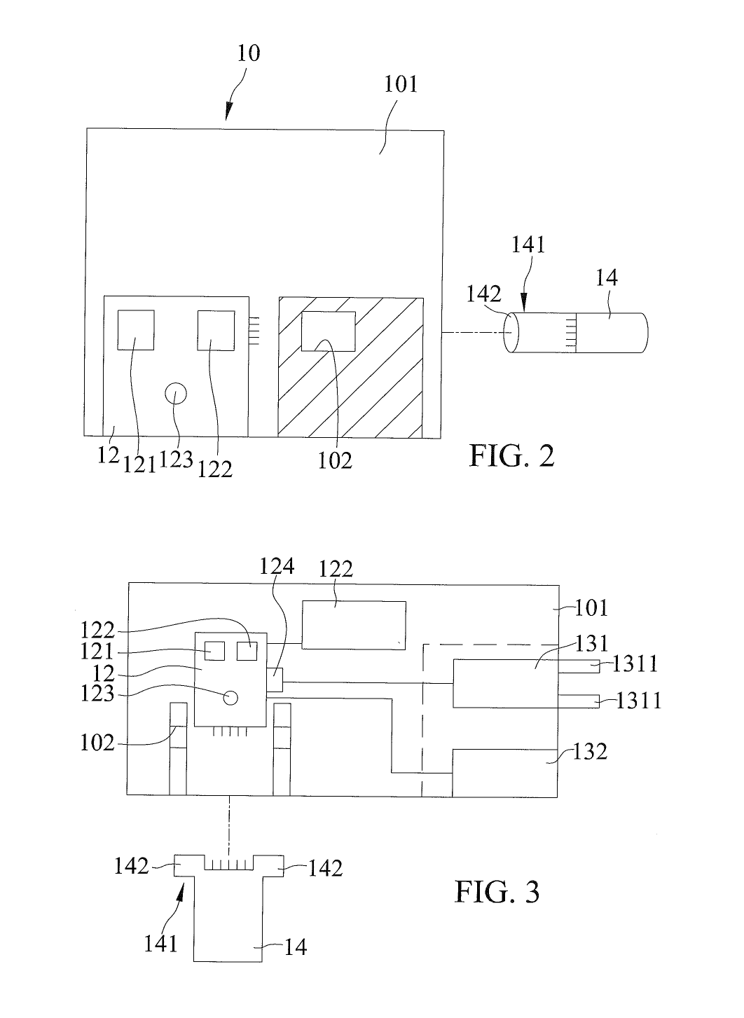

The detachable power supply 14 is detachably mounted on the housing 101. The detachable power supply 14 is coupled to the wireless communication module 11, the control module 12, and the accessory assembly 13. It should be appreciated that the detachable power supply 14 is configured to supply the wireless communication module 11, the control module 12, and the accessory assembly 13 with electric power. In the embodiment, the detachable power supply 14 may include a lock assembly 141 arranged to connect with the housing 101 to fix the detachable power supply 14 to the housing 101. FIGS. 2 and 3 show the lock assembly 141 of the detachable power supply 14 according to the present invention. The housing 101 may include two opposite walls each formed an engaging hole 102 thereon. The lock assembly 141 may include a pair of arms each having a flange 142 adapted to engage into each engaging hole 102 to prevent undesired disengagement of the detachable power supply 14 form the housing 101 of the luggage 10.

In view of the foregoing, the luggage 10 according to the present invention includes the detachable power supply 14. The user can remove the detachable power supply 14 from the housing 101 of the luggage 10 easily before boarding the aircraft.

Thus since the illustrative embodiment disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A luggage comprising:
a housing;
a wireless communication module disposed in the housing, with the wireless communication module configured to detect and receive a signal sent from a portable device;
a control module disposed in the housing and coupled to the wireless communication module, with the control module adapted to determine the signal received by the wireless communication module;
an accessory assembly coupled with and actuated by the control module; and
a detachable power supply detachably mounted on the housing, with the detachable power supply coupled to the wireless communication module, the control module, and the accessory assembly, with the detachable power supply configured to supply the wireless communication module, the control module, and the accessory assembly with electric power.

2. The luggage as claimed in claim 1, with the wireless communication module being a Bluetooth module adapted for receiving a Bluetooth signal, with the portable device having a Bluetooth emitter adapted for sending out the Bluetooth signal.

3. The luggage as claimed in claim 1, with the wireless communication module being a RFID module adapted for receiving a RFID signal, with the portable device having a RFID emitter adapted for sending out the RFID signal.

4. The luggage as claimed in claim 1, with the wireless communication module being a GPRS module adapted for receiving a GPRS signal, with the portable device having a GPRS emitter adapted for sending out the GPRS signal.

5. The luggage as claimed in claim 1, with the wireless communication module being a GSM module adapted for receiving a GSM signal, with the portable device having a GSM emitter adapted for sending out the GSM signal

6. The luggage as claimed in claim 1, with the wireless communication module being a UMTS module adapted for receiving a UMTS signal, with the portable device having a UMTS emitter adapted for sending out the UMTS signal.

7. The luggage as claimed in claim 1, with the wireless communication module being a LTE module adapted for receiving a LTE signal, with the portable device having a LTE emitter adapted for sending out the LTE signal

8. The luggage as claimed in claim 1, with the wireless communication module being a WiMAX module adapted for receiving a WiMAX signal, with the portable device having a WiMAX emitter adapted for sending out the WiMAX signal.

9. The luggage as claimed in claim 1, with the wireless communication module being a WLAN module adapted for receiving a WLAN signal, with the portable device having a WLAN emitter adapted for sending out the WLAN signal.

10. The luggage as claimed in claim 1, with the detachable power supply including a lock assembly arranged to connect with the housing to fix the detachable power supply to the housing.

11. The luggage as claimed in claim 1, with the accessory assembly including a locking mechanism having a pair of shackles to lock the luggage.

12. The luggage as claimed in claim 1, with the accessory assembly including a scale to measure a total weight of the luggage, with the scale having a display to indicate the total weight of the luggage.
